(19) United States
(12) Patent Application Publication
(10) Pub. No.: US 2009/0198523 A1
(43) Pub. Date: Aug. 6, 2009

(54) COMPUTER SYSTEM AND METHOD FOR DETERMINING AN INSURANCE RATE

(75) Inventors: Ralph Grieder, Zuerich (CH); Tobias Muster, Schindellegi (CH); Andreas Maechler, New York, NY (US); Yvan Pannatier, Zuerich (CH); Rolf Tanner, Waedenswil (CH)

Correspondence Address: OBLON, SPIVAK, MCCLELLAND MAIER & NEUSTADT, P.C., 1940 DUKE STREET, ALEXANDRIA, VA, 22314, US

(73) Assignee: Swiss Reinsurance Company, Zuerichch (CH)

(21) Appl. No.: 12/064,464

(22) PCT Filed: Aug. 24, 2005
(86) PCT No.: PCT/CH05/00492

§ 371 Date: Aug. 4, 2008

(51) Int. Cl. G06Q 40/00; G06Q 50/00

(52) U.S. Cl. 705/4

(57) ABSTRACT

In a computer system and computer implemented method for determining an insurance rate for terrorism-related property insurance, one or more industry classification attributes, indicative of an industry segment associated with the property, are selected. A basic rate is determined from rate values assigned to the selected industry classification attributes. One or more target classification attributes, indicative of the property's attractiveness as a target for terrorism, are also selected. An aggravating rate is determined from rate values assigned to the selected target classification attributes. The insurance rate is determined from the basic rate and the aggravating rate. The assignment of insurance rates to a property based on the selection of target classification attributes for the property makes it possible to include the risk of a terrorist attack in the rating process, without having to determine probability distributions of terrorist attacks or estimate expected loss caused by terrorist attacks.

### FIELD OF THE INVENTION

The present invention relates to a computer system and a computer implemented method for determining an insurance rate. Specifically, the present invention relates to a computer system and a computer implemented method for determining an insurance rate for terrorism-related property insurance.

### BACKGROUND OF THE INVENTION

For determining an insurance rate for non-private property insurance, typically, an industry segment is selected for the property and the insurance rate is determined based on rate values assigned to the industry segment selected. Non-private property insurance includes coverage for corporate, government or public buildings, for example. The rate values are assigned to the different industry segments based on historical loss experience. The payable insurance premium is based on the insurance rate and the total sum insured. However, determining an insurance rate for property insurance based on industry-specific classification of the property does not include any consideration of the special risk of a terrorist attack.

US 2004/0186753 describes a method for quantifying the insurance risk from a variety of catastrophic events including a terrorist attack. According to US 2004/0186753, a probability distribution for a terrorism event and a corresponding claim distribution are developed. A company's insurance risk is quantified based on the geographic distribution of its issued policies related to the terrorism event. One skilled in the art will understand, however, that it is extremely difficult to develop a reliable probability distribution for a terrorism event.

US 2004/0249679 describes systems and methods for qualifying expected loss due to terrorism. According to US 2004/0249679, the risk of a terrorist attack is assessed using a cognitive engineering process to create hierarchical decision-making models of terrorist behavior. Specifically, the factors that are deemed to influence the probability of occurrence of terrorist attacks against a property are based on Bayesian networks. The system determines estimates of expected loss considering possible modes and locations of attacks. Based on the estimates of expected loss, different premiums for terrorism insurance are defined.

### SUMMARY OF THE INVENTION

It is an object of this invention to provide an alternative computer system and an alternative computer implemented method for determining an insurance rate for terrorism-related property insurance. In particular, it is an object of the present invention to provide a computer system and a computer implemented method for determining an insurance rate for terrorism-related property insurance which do not require probability distributions of terrorist attacks or estimates of expected loss caused by terrorist attacks.

According to the present invention, these objects are achieved particularly through the features of the independent claims. In addition, further advantageous embodiments follow from the dependent claims and the description.

For determining an insurance rate for terrorism-related property insurance, selected are one or more industry classification attributes, indicative of an industry segment associated with the property. A basic rate is determined from rate values assigned to the industry classification attributes.

According to the present invention, the above-mentioned objects are particularly achieved in that one or more target classification attributes are selected which are indicative of the property's attractiveness as a target for terrorism. An aggravating rate is determined from rate values assigned to the target classification attributes. The insurance rate is determined from the basic rate and the aggravating rate. Preferably, the insurance rate is determined by multiplying the aggravating rate with the basic rate. Rather than focusing on the severity of the damage caused by terrorism or determining possible probability distributions of terrorism events, the selection of target classification attributes provides an assessment of a property's level of attraction of terrorism. The assignment of insurance rates to a property based on the selection of target classification attributes for the property makes it possible to include the risk of a terrorist attack in the rating process, without having to determine probability distributions of terrorist attacks or estimate the expected loss caused by terrorist attacks.

In an embodiment, defined ratios of the property are assigned to different target classification attributes and the aggravating rate is determined based on the target classification attributes and respective ratios. Assigning parts of a property to different target classification attributes makes it possible to assess properly the level of attraction of terrorism for a property that has different parts with different target classification attributes.

In an embodiment, the target classification attributes include geographic classification attributes indicative of the property's geographic location. Defined ratios of the property are assigned to different geographic classification attributes and the aggravating rate is determined based on the geographic classification attributes and the respective ratios. Including geographic classification attributes as target classification attributes makes it possible to assess a property's attractiveness as a target for terrorism based on the property's geographic location. For example, a geographic classification attribute related to the proximity of a landmark in Washington D.C. would be associated with a higher rate value than a geographic classification attribute related to a small town in a rural area. Assigning parts of a property to different geographic classification attributes makes it possible to assess properly the level of attraction of terrorism for a property that is distributed geographically, i.e. a property comprising parts situated in different geographic locations.

In an embodiment, the target classification attributes include ownership classification attributes indicative of the property's owner. The aggravating rate is determined based on the ownership classification attributes selected for the property. Including ownership classification attributes as target classification attributes makes it possible to assess a property's attractiveness as a target for terrorism based on the owner and/or tenant of the property. For example, an ownership classification attribute related to the U.S. Military would be associated with a higher rate value than an ownership classification attribute related to a relatively unknown family.

In an embodiment, the target classification attributes include technical classification attributes indicative of the property's practical or symbolic significance. Defined ratios of the property are assigned to different technical classification attributes. The aggravating rate is determined based on the technical classification attributes and the respective ratios. Including technical classification attributes as target classification attributes makes it possible to assess a property's attractiveness as a target for terrorism based on special (i.e. significantly higher-than-average) practical or symbolic significance associated with the property. For example, a property used for conferences of international organizations or for processing radioactive materials and a property including a landmark building would be associated with a technical classification attribute having a high rate value. Assigning only parts of a property to a technical classification attributes or assigning different parts of a property to different technical classification attributes makes it possible to assess properly the level of attraction of terrorism for a property that comprises different parts with different practical use or symbolic significance.

In an embodiment, the target classification attributes include publicity classification attributes indicative of public exposure and/or political perception of the property. The aggravating rate is determined based on the publicity classification attributes selected for the property. Including publicity classification attributes as target classification attributes makes it possible to assess a property's attractiveness as a target for terrorism based on a special (i.e. significantly higher-than-average) public exposure and/or political perception of the property. For example, a property associated with a major US corporation, an international political or financial organization, or a property associated with a racial/minority discrimination case, massive labor disputes or unethical corporate behavior would be assigned a publicity classification attribute having a significantly high rate value.

Preferably, stored are sets of target classification attributes and rate values assigned to the target classification attributes. A set of target classification attributes includes one of geographic classification attributes, indicative of the property's geographic location, ownership classification attributes, indicative of the property's owner, technical classification attributes, indicative of the property's practical or symbolic significance, and publicity classification attributes, indicative of public exposure and/or political perception of the property. The aggravating rate is determined based on the geographic classification attributes, the ownership classification attributes, the technical classification attributes, and/or the publicity classification attributes selected and assigned to a property. Preferably, an aggregated aggravating rate is determined by aggregating multiple aggravating rates, each determined based on one or more target classification attributes selected for the property. Subsequently, the insurance rate is determined by multiplying the aggregated aggravating rate with the basic rate. The sets of target classification attributes and the rate values assigned to the target classification attributes can be adapted to current events and developments in economy, politics, and terrorism. The aggravating rate or aggregated aggravating rate represents a weighting factor indicative of a property's level of attraction of terrorism.

In addition to a computer system and a computer implemented method for determining an insurance rate for terrorism-related property insurance, the present invention also relates to a computer program product including computer program code means for controlling one or more processors of a computer system such that the computer system performs the method, particularly, a computer program product including a computer readable medium containing therein the computer program code means.

### BRIEF DESCRIPTION OF THE DRAWINGS

The present invention will be explained in more detail, by way of example, with reference to the drawings in which:

FIG. 1 shows a block diagram illustrating schematically an exemplary configuration of a computer system for practicing embodiments of the present invention, said configuration comprising a computer with a display and data entry means.

FIG. 2 shows a flow diagram illustrating an example of a sequence of steps executed according to the present invention for determining an insurance rate for terrorism-related property insurance.

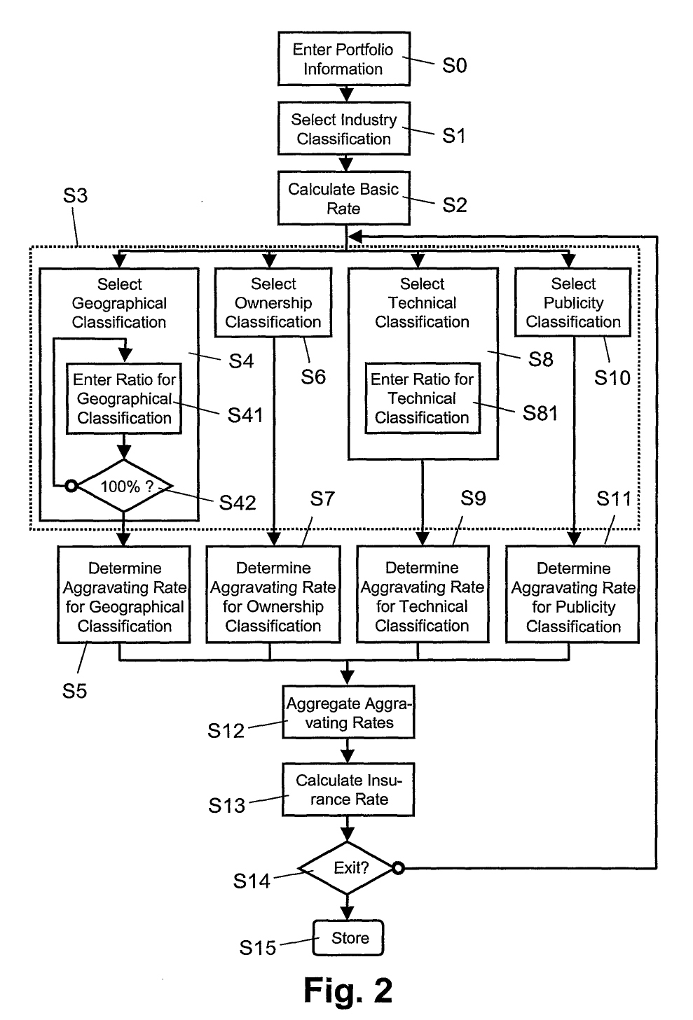

### DETAILED DESCRIPTION OF THE PREFERRED EMBODIMENTS

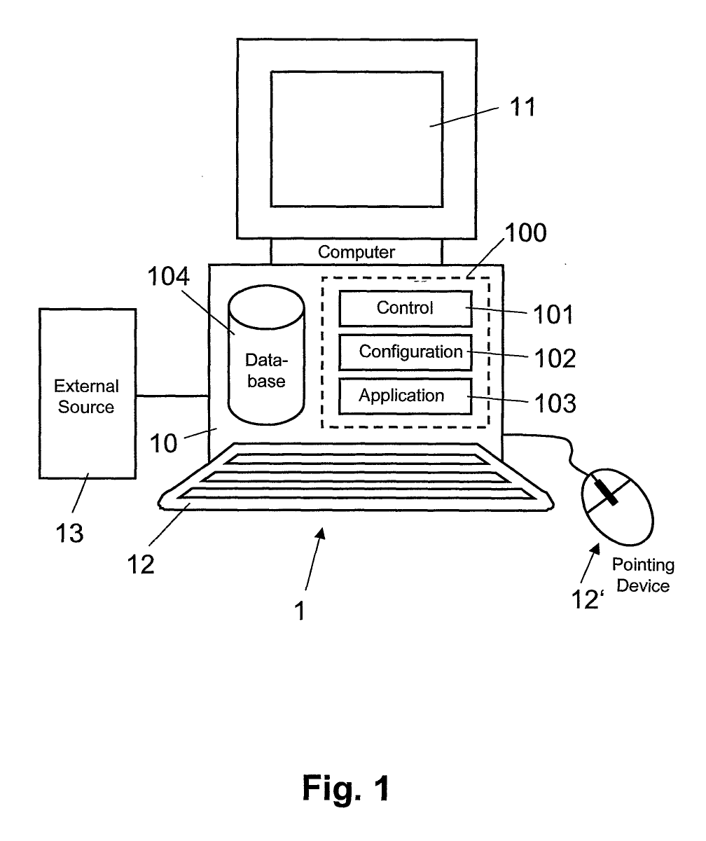

In FIG. 1, reference numeral 1 refers to a computer system for determining an insurance rate for terrorism-related property insurance. As is illustrated in FIG. 1, the computer system includes a computer 10, connected to a display 11 and to data entry means such as a keyboard 12 and/or a pointing device 12′. The computer 10 is provided with one or more processors and is implemented as a personal computer, for example.

As is illustrated in FIG. 1, the computer system 1 includes several functional modules: a control module 101, a configuration module 102, and an application module 103. The functional modules are implemented preferably as programmed software modules stored on a computer readable medium 100, connected fixed or removable to the processor(s) of the computer 10. One skilled in the art will understand, however, that the functional modules can also be implemented fully or in part by means of hardware. The computer system 1 also includes a database 104, implemented as a relational database, a spreadsheet or another structured data file.

The control module 100 is configured to provide to the user of the computer system 1 a user interface for selecting and activating the configuration module 102 or the application module 103. In a variant, the functional modules are implemented in one common computer program, for example as a spreadsheet application. The user interface is shown on display 11. Data and control commands are entered by the user using the data entry means.

The configuration module 102 is configured to manage target classification attributes and associated rate values. When selected and activated, the configuration module 102 makes it possible for a user to list, add, modify and delete target classification attributes and associated rate values in the database 104. As is shown in Table 1, a target classification attribute includes an attribute type, possibly an attribute subtype for hierarchically structured attribute types, and an attribute value. A rate value is assigned to each target classification attribute in the database 104. Table 1 shows different sets of target classification attributes: geographic classification attributes, ownership classification attributes, technical classification attributes, and publicity classification attributes. The geographic classification attributes are divided into subsets of different subtypes, category one, two, three and four. The technical classification attributes are divided into subsets of different subtypes, group one, two and three. For each attribute type/subtype of a target classification attribute, there is a list of defined attribute values. Each target classification attribute, defined by its attribute type/subtype and its attribute value, has a specific assigned rate value, for example in the range of [0 . . . 10]. The target classification attributes and their assigned rate values may vary over time depending on political, social and economic development. At this point in time, the geographic classification attributes of category one having the highest rate value may include geographical locations outside the United States, such as Afghanistan or Iraq, and inside the United States, such as Washington D.C. or the financial district of New York City. On the other hand, the geographic classification attributes of category four having the lowest rate value may include geographical locations outside the United States, such as Canada or Switzerland, and inside the United States, any place not included in categories one, two and three. Likewise, at present, ownership classification attributes having a high rate value include the US government, whereas the ownership classification attribute having the lowest rate value relates to any other ownership not included specifically in the list of defined attribute values. The technical classification attributes of group one having the highest rate value include landmark buildings. The technical classification attributes of group two having the second highest rate value include conventions and congress centers, radioactive materials processing plants, or storage facilities of hazardous goods. The publicity classification attributes having high rate values include major US corporations, US weapons industry, or international financial organizations.

TABLE 1

| Target Classification Attribute | | | |
|---|---|---|---|
| Attribute Type/Attribute Subtype | | Attribute Value | Rate Value |
| Geographic | Category 1 | {list of category 1 | [0 . . . 10] |
| Classification | | attribute values} | |
| Attribute | | | |
| Geographic | Category 2 | {list of category 2 | [0 . . . 10] |
| Classification | | attribute values} | |
| Attribute | | | |
| Geographic | Category 3 | {list of category 3 | [0 . . . 10] |
| Classification | | attribute values} | |
| Attribute | | | |
| Geographic | Category 4 | {list of category 4 | [0 . . . 10] |
| Classification | | attribute values} | |
| Attribute | | | |
| Ownership Classification Attribute | | {list of ownership | [0 . . . 10] |
| | | attribute values} | |
| Technical | Group 1 | {list of group 1 | [0 . . . 10] |
| Classification | | attribute values} | |
| Attribute | | | |
| Technical | Group 2 | {list of group 2 | [0 . . . 10] |
| Classification | | attribute values} | |
| Attribute | | | |
| Technical | Group 3 | {list of group 3 | [0 . . . 10] |
| Classification | | attribute values} | |
| Attribute | | | |

| | | |
|---|---|---|
| Publicity Classification Attribute | {list of publicity | [0 . . . 10] |
| | attribute values} | |

The database 104 also stores industry classification attributes managed by configuration module 102 and/or loaded as a data file from an external source 13 over a communication link. A rate value is assigned to each industry classification attribute in database 104. In the example illustrated in Table 2, an industry classification attribute is structured hierarchically and includes three levels of attribute values defining an industry segment. For each level of attribute value of an industry classification attribute, there is a list of defined attribute values. Each industry classification attribute, defined by its level one, two and three attribute values, has a specific assigned rate value, for example in the range of [1 . . . 10].

TABLE 2

| Industry Classification Attribute | | | |
|---|---|---|---|
| Level 1 Attribute | Level 2 Attribute | Level 3 Attribute | |
| Value | Value | Value | Rate Value |
| {list of level 1 | {list of level 2 | {list of level 3 | [1 . . . 10] |
| attribute values} | attribute values} | attribute values} | |

When selected and activated, application module 103 makes it possible for the user to determine an insurance rate for terrorism-related property insurance for a specific property or property portfolio.

In step S0, through a user interface provided on display 11, the application module 103 receives from the user general information about the particular case of property insurance. The general information includes, for example, account information, e.g. a company name or account identifier, the dates of inception and expiration of the insurance, a monetary currency and foreign exchange rate, a monetary amount indicating the limit of liability, a monetary amount indicating the attachment point, and a monetary amount indicating the total sum insured (TSI) exposed in the insurance layer.

In step S1, through a user interface provided on display 11, the application module 103 receives from the user industry classification attributes for the property or property portfolio to be insured. Specifically, the application module 103 receives from the user signals and/or instructions for selecting industry classification attributes from database 104. If the industry classification attributes are structured as illustrated in Table 2, the industry classification attributes are defined by the user selecting for each level of attribute values a value from the respective list of defined attribute values. For example, for each level of attribute values, the respective list of defined attribute values stored in the database 104 is made available to the user through a drop down pick list.

In step S2, the application module 103 calculates a basic rate based on the industry classification attributes selected in step S1. Particularly, the basic rate is determined from the total sum insured entered in step S0 and the rate value assigned in the database 104 to the industry classification attributes selected in step S1. In the present example, the rate value associated with the industry classification is determined by the industry classification attribute defined by the level one attribute value, selected from the list of level one attribute values, the level two attribute value, selected from the list of level two attribute values, and the level three attribute value, selected from the list of level three attribute values.

In step S3, through a user interface provided on display 11, the application module 103 receives from the user target classification attributes indicative of the property's attractiveness as a target for terrorism. Specifically, the application module 103 receives from the user signals and/or instructions for selecting target classification attributes from database 104.

In step S4, the application module 103 receives from the user selected geographic classification attributes. c In step S41, different ratios of the property, e.g. percentages of the total sum insured, are assigned to different geographic classification attributes applicable to the property. If the geographic classification attributes are structured as illustrated in Table 1, the ratios are entered, for example, in data entry fields organized as illustrated in Table 3, i.e. in data entry fields assigned to the different subtypes (categories) of the geographic classification attribute. The labels indicating the particular categories of geographic intensifiers are configured to be activated by the user to show the list of category attribute values stored in database 104 assigned to the respective category one, two, three or four. In the example illustrated in Table 3, the categories of the geographic classification attributes (geographic intensifiers) are further divided into different major geographic or political regions, specifically categories associated with the United States and categories not associated with the United States. In the example shown in Table 3, 10% of the total sum insured are associated with category two outside the United States, 20% of the total sum insured are associated with category three within the United States, and 70% of the total sum insured are associated with category four within the United States. In step S42, application module 103 checks if the ratios of the property assigned to the geographic classification attributes add up to 100%. If the ratios do not add up to 100%, the application module 103 receives further ratios in step S41. Otherwise, application module 103 proceeds to step S5. Depending on the embodiment, the rate value associated with a particular category of the geographic classification attributes is shown in the user interface, as illustrated in Table 3, or is not shown.

TABLE 3

| Categories of | | | |
|---|---|---|---|
| Geographic | % of TSI in Layer | % of TSI in Layer | |
| Intensifiers | (Non-USA) | (USA) | Rate Value |
| Category 1 | 0% | 0% | 9.00 |
| Category 2 | 10% | 0% | 7.00 |
| Category 3 | 0% | 20% | 4.00 |
| Category 4 | 0% | 70% | 2.00 |
| Total | 10% | 90% | 100% |
| Percentage | | | |

In step S5, the application module 103 determines the aggravating rate based on the geographic classification attributes selected in step S4. Specifically, the aggravating rate is determined based on the ratios specified for the different geographic classification attributes and the rate values assigned to the respective geographic classification attributes. For the example shown in Table 3, the aggravating rate based on the geographic classification attributes is calculated as 10%·7.00+20%·4.00+70%·2.00=2.90.

In step S6, the application module 103 receives from the user a selected ownership classification attribute. Specifically, the application module 103 receives from the user signals and/or instructions for selecting an ownership classification attribute from database 104. If the ownership classification attributes are structured as illustrated in Table 1, the ownership classification attribute (ownership intensifier) is selected by the user from the list of ownership attribute values. For example, the list of ownership attribute values stored in the database 104 is made available to the user through a drop down pick list.

In step S7, the application module 103 determines the aggravating rate based on the ownership classification attributes selected in step S6. Specifically, the aggravating rate is determined based on the rate value assigned to the respective ownership classification attributes.

In step S8, the application module 103 receives from the user selected technical classification attributes. Specifically, the application module 103 receives from the user signals and/or instructions for selecting technical classification attributes from database 104. In step S81, different ratios of the property, e.g. percentages of the total sum insured, are assigned to different technical classification attributes applicable to the property. If the technical classification attributes are structured as illustrated in Table 1, the ratios are entered, for example, in data entry fields organized as illustrated in Table 4, i.e. in data entry fields assigned to the different subtypes (groups) of the technical classification attributes. The labels indicating the particular groups are configured to be activated by the user to show the list of group attribute values stored in the database 104 assigned to the respective group one, two or three. In the example illustrated in Table 4, the groups of the technical classification attributes (groups of technical intensifiers) are further divided into different major geographic or political regions, specifically groups associated with the United States and categories not associated with the United States. In the example shown in Table 4, 10% of the total sum insured are associated with group two outside the United States and 20% of the total sum insured are associated with group three within the United States. Depending on the embodiment, the rate value associated with a particular group of the technical classification attributes is shown in the user interface, as illustrated in Table 4, or is not shown.

TABLE 4

| Group of Technical | % of TSI in Layer | % of TSI in Layer | |
|---|---|---|---|
| Intensifiers | (Non-USA) | (USA) | Rate Value |
| Group 1 | 0% | 0% | 9.00 |
| Group 2 | 10% | 0% | 7.00 |
| Group 3 | 0% | 20% | 3.00 |

In step S9, the application module 103 determines the aggravating rate based on the technical classification attributes selected in step S8. Specifically, the aggravating rate is determined based on the ratios specified for the different technical classification attributes and the rate values assigned to the respective technical classification attributes. For the example shown in Table 4, the aggravating rate based on the technical classification attributes is calculated as 10%·7.00+20%·3.00=1.30.

In step S10, the application module 103 receives from the user one or more selected publicity classification attributes. Specifically, the application module 103 receives from the user signals and/or instructions for selecting publicity classification attributes from database 104. If the publicity classification attributes are structured as illustrated in Table 1, the publicity classification attributes (publicity intensifiers) are selected by the user from the list of publicity attribute values. For example, the list of publicity attribute values stored in the database 104 is made available to the user through a list with check boxes, as illustrated in Table 5. Selection of mutual exclusive publicity classification attributes is suppressed. Depending on the embodiment, the rate value associated with a particular publicity classification attribute is shown in the user interface, as illustrated in Table 5, or is not shown.

TABLE 5

| Check-box | Publicity Intensifier | Rate Value |
|---|---|---|
| | Publicity Intensifier A | 9.00 |
| | Publicity Intensifier B | 8.50 |
| | . . . | . . . |
| X | Publicity Intensifier Q | 3.00 |
| | . . . | . . . |
| X | Publicity Intensifier N-1 | 1.50 |
| | Publicity Intensifier N | 1.00 |

In step S11, the application module 103 determines the aggravating rate based on the publicity classification attributes selected in step S0. Specifically, the aggravating rate is determined based on the sum of the rate values assigned to the selected publicity classification attributes. For the example shown in Table 5, the aggravating rate based on the publicity classification attributes is calculated as 3.00+1.50=4.50.

In step S12, the application module 103 calculates an aggregated aggravating rate as the sum of the aggravating rates determined in steps S5, S7, S9 and S11.

In step S13, the application module 103 calculates the insurance rate for the terrorism-related property insurance from the basic rate calculated in step S2 and from the aggregated aggravating rate calculated in step S12. For example, the insurance rate is calculated by multiplying the basic rate with the aggregated aggravating rate. The insurance rate is displayed in the user interface on display 11.

In step S14, the application module 103 checks if the user wants to exit the application module 103. If execution of the application module 103 is to be stopped, the application module 103 proceeds to step S15. Otherwise, the application module 103 continues in step S3.

In step S15, the application module 103 stores in a data file the general information received in step S0, the industry classification attributes received in step S1, the basic rate calculated in step S2, the target classification attributes and respective ratios received in step S3, the aggravating rates calculated in steps S5, S7, S9 and S11, the aggregated aggravating rate calculated in step S12, and the insurance rate calculated in step S13. For example, this data file is stored as a data record in database 104, as a spreadsheet, or as another structured data file.

It must be pointed out that the particular order of steps set forth in the specification should not be construed as limitations on the claims. The foregoing disclosure of the embodiments of the invention has been presented for purposes of illustration and description. It is not intended to be exhaustive or to limit the invention to the precise forms disclosed.

1-22. (canceled)

23. A computer system for determining an insurance rate for terrorism-related property insurance, the system comprising:
means for selecting one or more industry classification attributes, indicative of an industry segment associated with the property;
means for determining a basic rate from rate values assigned to the industry classification attributes;
means for selecting one or more target classification attributes, indicative of the property's attractiveness as a target for terrorism;
means for determining an aggravating rate from rate values assigned to the target classification attributes; and
means for determining the insurance rate from the basic rate and the aggravating rate.

24. The system according to claim 23, further comprising:
means for assigning defined ratios of the property to different target classification attributes; and
wherein the means for determining the aggravating rate is configured to determine the aggravating rate based on the target classification attributes and respective ratios.

25. The system according to claim 23, wherein the target classification attributes include geographic classification attributes indicative of the property's geographic location;
wherein the system further comprises means for assigning defined ratios of the property to different geographic classification attributes; and
wherein the means for determining the aggravating rate is configured to determine the aggravating rate based on the geographic classification attributes and respective ratios.

26. The system according to claim 23, wherein the target classification attributes include ownership classification attributes indicative of the property's owner; and wherein the means for determining the aggravating rate is configured to determine the aggravating rate based on the ownership classification attributes selected for the property.

27. The system according to claim 23, wherein the target classification attributes include technical classification attributes indicative of the property's practical or symbolic significance;
wherein the system further comprises means for assigning defined ratios of the property to different technical classification attributes; and
wherein the means for determining the aggravating rate is configured to determine the aggravating rate based on the technical classification attributes and respective ratios.

28. The system according to claim 23, wherein the target classification attributes include publicity classification attributes indicative of public exposure and/or political perception of the property; and wherein the means for determining the aggravating rate is configured to determine the aggravating rate based on the publicity classification attributes selected for the property.

29. The system according to claim 23, further comprising:
means for storing sets of the target classification attributes and rate values assigned to the target classification attributes, a set of the target classification attributes including one of geographic classification attributes, indicative of the property's geographic location, ownership classification attributes, indicative of the property's owner, technical classification attributes, indicative of the property's practical or symbolic significance, and publicity classification attributes, indicative of public exposure and/or political perception of the property;
wherein the means for determining the aggravating rate is configured to determine an aggregated aggravating rate by aggregating multiple aggravating rates, each determined based on one or more target classification attributes selected for the property; and
wherein the means for determining the insurance rate is configured to determine the insurance rate by multiplying the aggregated aggravating rate with the basic rate.

30. A computer implemented method for determining an insurance rate for terrorism-related property insurance, the method comprising:
selecting one or more industry classification attributes, indicative of an industry segment associated with the property;
determining a basic rate from rate values assigned to the industry classification attributes;
selecting one or more target classification attributes, indicative of the property's attractiveness as a target for terrorism;
determining an aggravating rate from rate values assigned to the target classification attributes; and
determining the insurance rate from the basic rate and the aggravating rate.

31. The method according to claim 30, further comprising:
assigning defined ratios of the property to different target classification attributes; and
wherein the aggravating rate is determined based on the target classification attributes and respective ratios.

32. The method according to claim 30, wherein the target classification attributes include geographic classification attributes indicative of the property's geographic location;
wherein the method further comprises assigning defined ratios of the property to different geographic classification attributes; and
wherein the aggravating rate is determined based on the geographic classification attributes and respective ratios.

33. The method according to claim 30, wherein the target classification attributes include ownership classification attributes indicative of the property's owner; and wherein the aggravating rate is determined based on the ownership classification attributes selected for the property.

34. The method according to claim 30, wherein the target classification attributes include technical classification attributes indicative of the property's practical or symbolic significance;
wherein the method further comprises assigning defined ratios of the property to different technical classification attributes; and
wherein the aggravating rate is determined based on the technical classification attributes and respective ratios.

35. The method according to claim 30, wherein the target classification attributes include publicity classification attributes indicative of public exposure and/or political perception of the property; and wherein the aggravating rate is determined based on the publicity classification attributes selected for the property.

36. The method according to claim 30, further comprising:
storing sets of the target classification attributes and rate values assigned to the target classification attributes, a set of the target classification attributes including one of geographic classification attributes, indicative of the property's geographic location, ownership classification attributes, indicative of the property's owner, technical classification attributes, indicative of the property's practical or symbolic significance, and publicity classification attributes, indicative of public exposure and/or political perception of the property;
wherein the aggravating rate is determined by aggregating multiple aggravating rates, each determined based on one or more target classification attributes selected for the property; and
wherein the insurance rate is determined by multiplying the aggregated aggravating rate with the basic rate.

37. A computer program product including a computer readable medium containing therein computer program code means for controlling a computer such that the computer:
selects one or more industry classification attributes, indicative of an industry segment associated with a property;
determines a basic rate from rate values assigned to the industry classification attributes;
selects one or more target classification attributes, indicative of the property's attractiveness as a target for terrorism;
determines an aggravating rate from rate values assigned to the target classification attributes; and
determines an insurance rate for terrorism-related insurance for the property from the basic rate and the aggravating rate.

38. The computer program product according to claim 37, further comprising computer program code means for controlling the computer such that the computer:
assigns defined ratios of the property to different target classification attributes; and
determines the aggravating rate based on the target classification attributes and respective ratios.

39. The computer program product according to claim 37, further comprising computer program code means for controlling the computer such that the computer:
selects as one of the target classification attributes one or more geographic classification attributes, indicative of the property's geographic location;
assigns defined ratios of the property to different geographic classification attributes; and
determines the aggravating rate based on the geographic classification attributes and respective ratios.

40. The computer program product according to claim 37, further comprising computer program code means for controlling the computer such that the computer:
selects as one of the target classification attributes an ownership classification attribute, indicative of the property's owner; and
determines the aggravating rate based on the ownership classification attribute selected for the property.

41. The computer program product according to claim 37, further comprising computer program code means for controlling the computer such that the computer:
selects as one of the target classification attributes one or more technical classification attributes, indicative of the property's practical or symbolic significance;
assigns defined ratios of the property to different technical classification attributes; and
determines the aggravating rate based on the technical classification attributes and respective ratios.

42. The computer program product according to claim 37, further comprising computer program code means for controlling the computer such that the computer:
selects as one of the target classification attributes one or more publicity classification attributes, indicative of public exposure and/or political perception of the property; and
determines the aggravating rate based on the publicity classification attributes selected for the property.

43. The computer program product according to claim 37, further comprising computer program code means for controlling the computer such that the computer:
stores sets of the target classification attributes and rate values assigned to the target classification attributes, a set of the target classification attributes including one of geographic classification attributes, indicative of the property's geographic location, ownership classification attributes, indicative of the property's owner, technical classification attributes, indicative of the property's practical or symbolic significance, and publicity classification attributes, indicative of public exposure and/or political perception of the property;
determines the aggravating rate by aggregating multiple aggravating rates, each determined based on one or more target classification attributes selected for the property; and
determines the insurance rate by multiplying the aggregated aggravating rate with the basic rate.
